(19) United States
(12) Patent Application Publication
(10) Pub. No.: US 2008/0044635 A1
(43) Pub. Date: Feb. 21, 2008

(54) Barrier film for flexible articles

(76) Inventors: Michael O'Neill, Middletown, DE (US); Donald Allan Sandusky, Landenberg, PA (US)

Correspondence Address: MCCARTER & ENGLISH, LLP;BASIL S. KRIKELIS, Renaissance Centre, 405 N. King Street, 8th Floor, WILMINGTON, DE, 19801, US

(21) Appl. No.: 11/810,495

(22) Filed: Jun. 6, 2007

Related U.S. Application Data
(60) Provisional application No. 60/811,924, filed on Jun. 8, 2006.

(51) Int. Cl. B32B 7/02; B32B 37/06; B32B 37/10

(52) U.S. Cl. 428/212; 156/308.2

(57) ABSTRACT

This invention relates to an improved gas impermeable barrier membrane having a configuration whereby the membrane is flexible and can retain its barrier performance and integrity when applied to a substrate that is stretched, flexed and or compressed. The inventive membrane is useful for significantly reducing air permeability in inflated articles that are flexible and require a significant amount of stretch to function. The invention is also directed to the construction of such a membrane and its composition.

### CROSS REFERENCE TO RELATED APPLICATIONS

The present application claims the benefit of U.S. Provisional Application Ser. No. 60/811,924 filed Jun. 8, 2006, the disclosure of which is expressly incorporated herein by reference in its entirety.

### FIELD OF THE INVENTION

This invention relates to an improved gas impermeable barrier membrane having a configuration that is flexible while retaining its integrity when applied to a substrate that stretches, flexes and/or compresses. The inventive membrane is useful for significantly reducing air permeability in inflated articles that are flexible and require a significant amount of stretch to function. The invention is also directed to the composition, construction and manufacturing process of such a membrane.

### BACKGROUND OF THE INVENTION

To maintain good gas impermeability, barrier membrane manufacturers apply barrier materials such as polyvinylidene chloride (PVDC), Polyvinyl alcohol (PVOH), Ethylene vinyl alcohol (EVOH), nylon, or nano-clays to tough plastic or similar non stretchable substrates. The reason for using these materials (i.e. the hard crystalline structure in the case of plastics like PVDC or the mineral in the case of clay) on tough plastic or otherwise low elastic substrates is that they tend to crack, break and/or flake off if the substrate is stretched.

PVOH is a highly crystalline polymer that forms a film by drying the polymer molecules from a water solution at a temperature higher than the minimum film forming point so that while drying into a film, the molecular motion moves the long chain molecules together into close proximity (1 or 2 Angstroms distance apart) and then aligns them into linear arrays that are held together by hydrogen bonding or van der Waals forces.

Films formed by this process maintain very good barrier properties but are very crystalline and of little practical use on flexible substrates because they are brittle and can easily be damaged through stress cracking or due to poor adhesion to any supporting material. Delamination of the barrier coating is a problem that is induced by the stress created by the difference in the stress/strain relationship between the barrier and substrate materials. Manufacturers use various plasticizers in the barrier coatings in an attempt to overcome these issues and do so quite successfully in the cases where the production processes are mild enough to prevent plasticizer migration and loss or where the application is less demanding in terms of mechanical stress or barrier requirements. However, when these commercially plasticized films are use in production processes that require laminates with cure temperatures above 80° C. the plasticizer tends to migrate out of the film or into localized regions of higher concentration in a way that creates highly crystalline regions where there is little plasticization. The PVOH coating then cracks and peels from its substrate. The problem is further exacerbated by the loss of residual water from the film that has a significant effect on polymer crystallinity and brittleness. One example of this is the use of a commercial PVOH film in a play ball construction that is plasticized with 20% weight glycerine and has approximately 8% by weight water. When processed at temperatures higher than 80 deg C. the water is driven off and the resulting build up of crystallinity creates channels for glycerol (plasticizer) migration. The loss of plasticizer creates regions of very highly crystalline hard segments that have improved barrier properties but are too brittle to be of any practical use. When a ball of such a construction is bounced, the PVOH film is brittle and inelastic, creating an undesirable rebound. Further, upon bouncing of such a ball, the film itself breaks with the subsequent loss of the barrier properties.

In general when a standard barrier coating such as a nano-clay or PVDC is applied to a stretchable or flexible substrate, the integrity of the barrier coating becomes compromised each time the substrate is stretched. Just like in the case of the plasticized and heat treated PVOH coating, the crystalline structure is brittle and when stretched, the forces holding the molecules together easily break, thereby destroying the barrier's integrity. Under such stretch forces the crystals form shear planes that crack into the platelet-like structures and the molecules separate, creating large gaps between the crystalline regions or break and even flake off the substrate that is used to support the barrier.

There is thus a need for a gas impermeable barrier film that can retain its integrity while undergoing standard product manufacturing processes for an inflatable articles, and continue to maintain its integrity through the rigors of flexion and compression that inflatable articles undergo.

### SUMMARY OF THE INVENTION

The invention is directed to a barrier membrane for flexible articles comprising a) a first stretchable film layer, wherein said first stretchable film layer is substantially water impervious; b) a barrier film layer, wherein said barrier film layer is substantially gas impermeable; and c) a second stretchable film layer, wherein said second stretchable film layer is substantially water impervious; wherein said barrier film layer comprises a residual moisture level of between 1% and 20% by weight.

The invention is further directed to a barrier membrane for flexible articles comprising a stretchable film layer, wherein said stretchable film layer is substantially water impervious, and a barrier film layer, wherein said barrier film layer is substantially gas impermeable, and wherein said barrier film layer is encapsulated by said stretchable film layer in the configuration of a closed, gas-filled chamber.

The invention is also directed to processes for preparing the barrier membrane of the invention, such as a process comprising the steps of a) providing a first, water impervious stretchable film layer; b) applying a gas impermeable barrier film layer onto said first stretchable film layer; c) applying a second, water impervious stretchable film layer onto said barrier film layer; and (d) adhering the layers together using high pressure and high temperature, whereby said barrier film layer comprises a residual moisture of 1% to 20% by weight.

### BRIEF DESCRIPTION OF THE DRAWINGS

FIG. 1 is a schematic drawing showing one embodiment of the flexible barrier membrane of the invention.

FIG. 2 is a schematic drawing showing an alternative embodiment of the flexible barrier membrane of the invention.

FIG. 3 is a schematic drawing showing another embodiment of the flexible barrier membrane of the invention.

FIG. 4 is a schematic drawing showing an alternative embodiment of the flexible barrier membrane of the invention wherein the barrier layer is encapsulated within a closed cavity.

FIG. 5 is a schematic drawing showing an embodiment of a process for preparing the flexible barrier membrane of the invention.

FIG. 6 is a flow chart depicting an example of a dip coating process for preparing the flexible barrier membrane of the invention.

FIG. 7 is a chart setting forth the rate of water generation by aluminum trihydrate under high temperature conditions.

FIG. 8 is a chart comparing the rate of moisture loss through various membrane barrier films under high temperature conditions.

FIG. 9 is a chart comparing the amount of air seepage through various treated and untreated PVC sheets.

FIG. 10 is a table setting forth the rate of air diffusion through various treated and untreated membrane materials.

FIG. 11 is a bar graph depicting a comparison of air retention performance of inflatable articles using various treated and untreated membrane materials over time.

FIG. 12 is a chart comparing the rate of barrier film moisture loss for various PVOH films.

### DETAILED DESCRIPTION OF THE INVENTION

The invention is directed to a flexible barrier membrane for use on flexible articles comprising a barrier film layer sandwiched between a first stretchable film layer and a second stretchable film layer, or otherwise encapsulated by a stretchable film layer.

The invention is also directed to a process for preparing the flexible barrier membrane of the invention comprising the steps of a) providing a first stretchable film layer b) applying a barrier film layer onto said first stretchable film layer; c) adhering said layers to form a multi-film membrane; and d) applying a second stretchable film layer onto the barrier film layer of the multi-film membrane whereby said barrier film layer is sandwiched between said first stretchable film layer and said second stretchable film layer.

Alternatively, the invention can be prepared such that the barrier film is applied onto an elastomeric (substrate) film that forms the inside of a chamber or cavity of an inflatable article, and, when sealed, the barrier film is totally encapsulated within the chamber or cavity, whereby virtually no residual moisture is lost from the chamber.

Our invention addresses the deficiencies of existing barrier films or membranes that lose their integrity when exposed to significant stretch or fatigue resulting from dynamic flexing or direct stretch and compression cycles like those to be experienced in an inflatable article such as a ball, tire, air mattress, float or the like. In particular, the barrier membrane of the invention is capable of retaining its integrity to a much greater extent than barrier films of the prior art, and, as a result, significantly improves gas retention within flexible inflatable articles.

The barrier film layer of the barrier membrane of the invention preferably comprises a gas impermeable material, such as a material made from highly crystalline polymer materials including, but not limited to Poly Vinyl Alcohol (PVOH), Ethylene-Vinyl Alcohol (EVOH), and polyvinylidene chloride (PVDC). In a preferred embodiment, the barrier membrane of the invention comprises barrier layer which is either sandwiched between two stretchable films or adhered to a single stretchable film and encapsulated in a chamber. The barrier film is adhered to the stretchable film(s) by drying or by otherwise laminating or adhering said layers to form a laminated or multi-film membrane The stretchable film(s) can accommodate the stretch requirements of the inflatable article without losing the performance integrity of the stretchable film(s). The stretchable film(s) are preferably moisture impermeable and made from a flexible material such as, for example, an elastomeric film such as natural rubber, synthetic rubber or other elastomeric or plasticized plastic material such as PVC or the like. The stretchable film(s) of the invention often serve as a substrate onto which the barrier film is adhered.

When the term “PVOH” is used in this document, it is intended to refer to any water soluble polyhydroxy compound with repeating units of CH₂.CHOH in the polymer chain. The weight average molecular weight of the PVOH can range from about 10,000 to about 200,000. In a preferred embodiment, PVOH has a weight average molecular weight greater than 80,000 and is used at a concentration in water of about 5 to about 14 percent by weight. The invention encompasses derivatives of water-soluble polyhydroxy compounds, particularly those which are partially hydrolyzed in which some of the hydroxyl groups are acetylated. The percent of acetate groups replaced by hydroxyl groups is the degree of hydrolysis. The invention further encompasses PVOHs with a degree of hydrolysis greater than 87 percent. To enhance elasticity in the barrier film, the preferred embodiment employs a PVOH which is about 87 to about 89 percent hydrolyzed. Other polyvinyl alcohols having a degree of hydrolysis up to over 99 percent can also be used, such as, for example, Elvanol 70-31 sold by Du Pont de Nemours Inc. Another preferred material is Elvanol 51 (87% hydrolyzed) sold by Du Pont de Nemours Inc. Other types of PVOHS that are chemically modified or otherwise altered to provide the benefits of the invention are also included. For example, water resistance of a dried PVOH film can be enhanced by cross linking the backbone polymer of the PVOH using aldehydes or aldehyde donors in the formulation. Other modifications of the PVOH backbone include reaction of the hydroxyl groups to form ethers, esters, acetals and ketals.

It is preferred that the barrier film of the invention preferably contains between about 1% and 20%, and more preferably, about 2% to about 14%, weight residual water upon formation of the barrier membrane of the invention. It is also preferred that the barrier film contains between about 5% and about 50% weight of a plasticizer that is solid at room temperature and does not migrate during barrier membrane formation.

Preferred plasticizers (also referred to as “solids” in this document) for this invention include sugar alcohols such as dextrose, maltitol, erythritol and sorbitol. These compounds include mono- and di-saccharides including glucose, dextrose including the monohydrate, sucrose, arabinose, lactose, mannose, maltose, fructose, galactose, amylose, allose, altrose, talose, gulose, idose, erythrose, threose, lyxose, xylose, arabinose, rhamnose, and cellobiose. Low molecular weight water soluble polysaccharides such as starches are also included within the scope of this invention. Other plasticizers that can be included in this invention's formulation are glycerol, various phthalates, 2,3 butandiol, and polyethylene glycols.

The barrier film of the invention is initially formed as a solution, and can then either be directly applied as a solution to the stretchable film substrate as a coating and dried thereon, or pre-dried into a film (i.e. the barrier film) and then formed into appropriate shape for adhesion to the stretchable film substrate.

It may be appropriate, and often is preferred, to incorporate additional ingredients to the barrier film solution that would add one or more beneficial characteristics to the barrier solution, and ultimately the barrier membrane of the invention. Some examples of beneficial ingredients would include water-shedding compounds that give up water at a very slow rate, for example, taking longer than 20 minutes while subject to temperatures greater than 100° C. as would be experienced in rubber curing or plastic laminating processes (See Example 5). In such a case, the water that evaporates from the barrier film or coating during the curing or laminating process is replenished by that which is given up by the water shedding compound which prevents the barrier film from being over-dried to potentially a brittle state. Examples of water-shedding compounds include silica gel, aluminum trihydrate, magnesium hydroxide, activated carbon and various other highly hydrated organic and inorganic compounds.

Other beneficial ingredients that can be added to the barrier film solution in small amounts without substantially altering the function of the barrier membrane performance include antioxidants, biocide, anti-mold materials, coloring fillers and viscosity thickeners. For example, up to 0.5% by weight of anti-mold ingredients like sodium diacetate, calcium proprionate and potassium sorbate can be added to the solution to prevent spores and mold growth on the barrier film.

To prevent gelation of the barrier solution before use, non-ionic surfactants and in particular those containing alkyl ethoxylated formulations such as Triton-x® (Rohm & Haas) surfactants can be added up to about 0.3 or 0.4% by weight. Viscosity stability of the barrier coating solution can be increased by adding small amounts of viscosity stabilizers such as thiocyanate, phenol, butyl alcohol or isopropyl alcohol using standard methods known in the art. For improved processing, the viscosity of the barrier solution can be increased or thickened and extended using thickeners or extenders such as starch, methyl cellulose, polyacryl amide, alginic acid soda, clays, calcium carbonate, dextrin or casein.

Small amounts of nano-clays of the montmorillonite type as sold under the trade name Cloisite® (Southern Clay Products, Inc.) can also be added to enhance solution stability, extend viscosity and to affect drying rates and improve barrier performance. (see Example 6).

If desirable, up to about 10% of aqueous polyurethane or other elastic/elastomers can be added to the barrier solution as a latex to lower overall Tg (glass transition temperature) and improve the elastic behavior of the barrier film.

As preliminarily described above, the barrier film or coating of the invention is preferably sandwiched between elastomeric film(s) or encapsulated within an inflatable chamber. It is preferred that the barrier film is contained within a controlled environment where relatively no significant moisture either enters or leaves the film. Consequently, after curing/drying the film remains in a continuously plasticized state due to both the residual water content and the plasticizer content, and as a result, the film does not exhibit embrittlement that typically occurs upon loss of the film's residual water content and the subsequent creation of too much crystallinity in the less plasticized and drier regions. It is therefore preferred that the flexible film(s) of the invention sandwich or encapsulate the barrier film in such a way that, when the barrier membrane of the invention is in use, the barrier film retains a residual water content of about 1% to 20% weight range, and more preferably, about 2% to 14% weight range so that no embrittlement occurs. In addition, it is preferred that the plasticizer(s) also remains within the range of about 5% to about 50% as the plasticizer attracts water and helps maintain polymer flexibility, as well as enhance barrier properties due to the plasticizer's crystallinity.

A resulting advantage of the invention's barrier film properties is that they remain the same or better because the barrier film remains primarily intact while under stress and because the plasticizers enhance barrier properties. Otherwise stated, a unique advantage of this encapsulated barrier membrane composition and configuration is that the barrier material does not breakdown, degrade or yellow with a subsequent loss in performance (See Example 6).

Inflatable products that incorporate the barrier membrane of the invention can be subjected to many cycles of flexing and stretching without becoming embrittled and without cracking or significant loss of the membranes barrier properties. The membrane of the invention can be elongated to 350% and can undergo more than 12,000 cycles of a one inch deflexion without cracking or breaking (see Example 4). Thus an inflatable article like a ball, tire or air bed can undergo many cycles of use and maintain their air retention for up to one hundred times or more their normal inflation period.

An inflated article, such as a sports ball or the like, incorporating the flexible barrier membrane of the invention will ultimately remain inflated much longer than inflated products that incorporate conventional flexible barriers. In an example of the application of this technology to inflatable balls, our tests indicate an improvement over conventional inflatable balls of at least 20 to 100 times better inflation retention. Similar tests using standard 9.7 K80 air bed PVC showed improvements in air retention of more than 30 times that or PVC without the coating (See Examples 7 and 8). Such products should retain the functional air pressure for more than a year (See Example 9).

In addition to increased air pressure retention, the flexible barrier membrane of the invention has the added advantage that it uses less material than is typically used in barrier membranes of the past. To address stretchable products, the incumbent or past applications of barrier technology used, for example, nano-clay platelet structures. The nano-clays were placed in aqueous emulsions or dispersions of rubbers, or into solvated rubber compounds as suspended clay platelets. These solutions require high clay loading, from 5% to more than 25%, to achieve good barrier properties. The resulting structures are rigid and non uniform brittle films that break and fatigue poorly. When damaged in a flexible or stretch application, they are permanently damaged and incapable of air retention thereafter. The end result is the formation of very non uniform films full of crests and troughs and pin hole type defects when deployed onto a product. The flexible barrier film of the invention does not suffer from these deficiencies as described earlier.

Another distinct advantage of the invention, particularly when the barrier film is applied to the substrate as a solution to form a coating, is that the polymer will plug any pinholes in the substrate and prevent gas leakage. This is particularly important to manufacturers who experience defective articles because of imperfections in the material stock being used to make the article. The same effect holds true in alternative embodiments of the invention such as there where the barrier film is pre-dried and then laminated onto the substrate (e.g. the inside of ball bladders that are cured under pressure), or in the case of dip coated bladders such as may be used in a soccer ball's natural rubber latex bladder (discussed below). Production defects derived from pin hole leaks in all inflatable articles would be eliminated by any of the embodiments of the invention.

Manufacture of Flexible Barrier Membrane

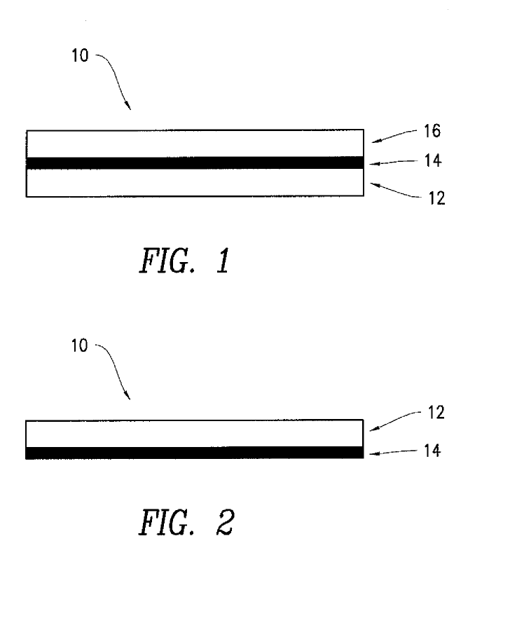

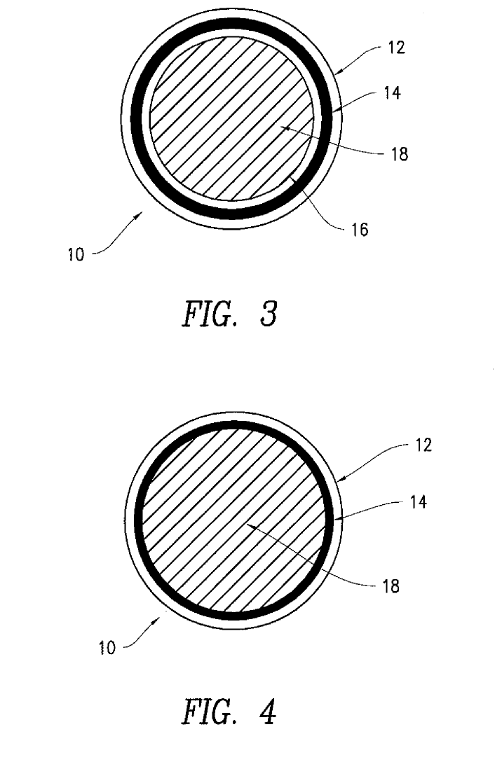

As best depicted in FIG. 1, a preferred process for manufacturing the barrier membrane (10) of the invention employs a first stretchable film layer or substrate (12) made of a natural rubber, synthetic rubber or other elastomeric or plasticized plastic material such as PVC or the like. Once the first stretchable film layer (12) is positioned, the barrier film (14) is formed using a barrier solution comprising an appropriate polymer, such as PVOH, with a plasticizer, and, if desired, one or more of the additional ingredients of this invention. The barrier layer (14) is dried and then applied to the first stretchable film layer (12) as a pre-formed film. The barrier film (14) is adhered to the substrate (12) using an adhesive such as a compatible polymer adhesive, a pressure sensitive adhesive or a rubber cement. Alternatively the barrier film (14) can be laminated to the substrate (12) using any lamination technique known in the art such as thermal, pressure, radio frequency & ultra sonic welding or the like. At this point a second stretchable film (16), such as an elastomeric material, is applied on top of the barrier layer (14) to create the three layered barrier membrane of the invention (10) that is both stretchable and capable of keeping its barrier properties even after being subjected to high temperatures greater than 100 deg C. or being stretched, flexed and/or compressed numerous times.

Another preferred process for manufacturing the barrier membrane (10) of the invention employs a first stretchable film layer or substrate (12) of a natural rubber, synthetic rubber or other elastomeric or any plasticized plastic material such as PVC or Nylon. Once the first stretchable film layer (12) is in position, a coating of barrier material (14), such as one containing PVOH and, if desired, one or more of the ingredients of this invention, is applied in the form of a solution that is formulated with adequate solids concentration of between 5 and 50% and viscosity between 50 and 10,000 cp to wet and easily adhere to the substrate (12) when sprayed, brushed, poured or otherwise applied to the surface to form the barrier layer (14). The concentration and viscosity of the barrier solution can be readily altered to create different thicknesses of the final dried coating by altering the solids content of the solution. For example a 45% solids and 9000 cp viscosity solution will result in a minimum 1.5 mil thick coating after drying if poured over the surface of a butyl rubber substrate at an angle of 45 degree to horizontal plane. This subcomponent consisting of the elastomeric substrate (12) and the barrier coating (14) is then placed in a drying oven and dried at temperatures between 60 and 200 deg C. at various pressures for period ranging between 2 and 30 minutes. The dried barrier coating (14) should preferably contain coating containing between about 1 and 20% residual water content is then covered by another layer of elastomeric material (16) that seals the barrier coating (14) between an inner (12) and outer elastomeric layer (16). An adhering formulation may be used at this point to place the second elastomeric film (16) on to the barrier coating (14). The whole elastomeric sphere component consisting of a elastomeric inner sphere (12), an elastic barrier layer (14) and an outer elastomeric sphere (16) is then cured or laminated in a mold at temperatures between 120 & 200 deg C. while applying air pressure between 1 kg/cm2 and 14 kg/cm2 to the internal surface of the inner elastomeric sphere. The shape of the membrane can be flat, or any shape or cut length. This example uses a sphere to demonstrate the art as applied to ball manufacture.

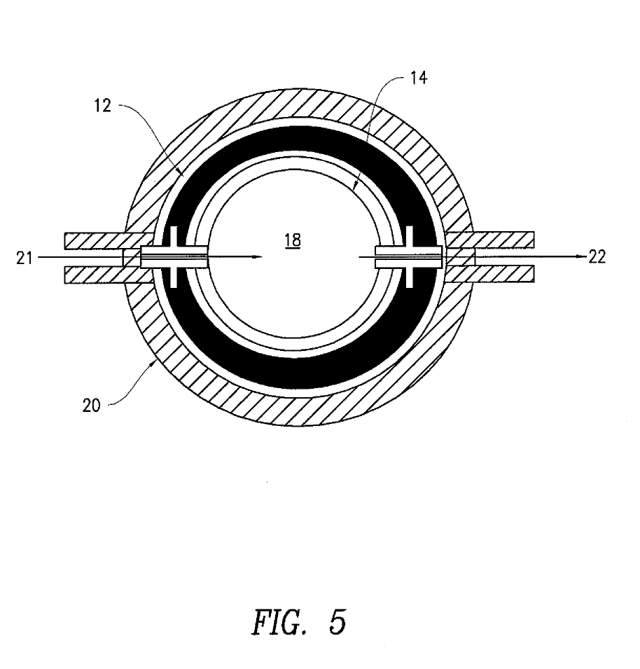

Another preferred process for manufacturing the flexible barrier membrane of the invention (10) is depicted in FIG. 5 and employs a first stretchable film layer or substrate (12) of a natural rubber, synthetic rubber or other elastomeric or any plasticized plastic material such as PVC or the like. This first stretchable film layer (12) is formed from a bladder or an air chamber (18) with valves (21, 22) or other devices to control ingress into (21) or out (22) of the chamber. A coating of barrier material (14) is formed, such as PVOH with one or more of the additional ingredients of this invention, is injected into the chamber formed by the initial layer of elastomeric material (12). The barrier material (14) is in the form of a solution that is preferably formulated with adequate solids concentration of between 5 and 50% and viscosity between 50 and 10,000 cp to wet and easily adhere to the internal walls (12) of the chamber (18). The amount of barrier solution injected into the deflated chamber (18) can be varied so that when the elastomeric chamber (18) is mangled or the exterior of the chamber (18) is rubbed it spreads the barrier material around the inside (12) of the chamber (18). For example, between 3 and 30 gms of material would be adequate for a ball bladder. Depending on the process needs related to the material condition and the required properties of the fully formed elastomeric material, the whole membrane configuration consisting of a elastomeric inner chamber (18), an elastic barrier coating (14) on the inside wall (12) of the elastomeric chamber (18) is then cured or laminated in a mold at temperatures between 120° and 200° C. while reinflating the bladder and applying dry air into the chamber (18) under pressure between 1 kg/cm2 and 14 kg/cm2 to the internal wall (12) of the elastomeric chamber. In this configuration the process is held at a curing temperature for a fixed time (from about 5 to 15 minutes) while the chamber (18) is under air pressure in the range 1 to 20 kg/cm2. While drying a jacketed mold surrounds the elastomeric chamber and provides a temperature of between 100 and 200° C. Because the solution of barrier material (14) coating the internal surface (12) of the chamber (18) gives off water as it dries, this water must be removed from the chamber (18). Such is accomplished by the air pressure system (20) shown in FIG. 5 which uses either a pressure relief valve or bleed valve (22) system to release moisture while relieving excess vapor pressure from the chamber. Alternatively the system can be set up to continuously purge the pressurized elastomeric chamber so that all moisture evaporating from the coating is removed from the chamber (18). The dried barrier coating (14) adheres strongly to the inside (12) of the elastomeric chamber's walls, contains between about 1% and 20% residual water content and remains elastic and flexible.

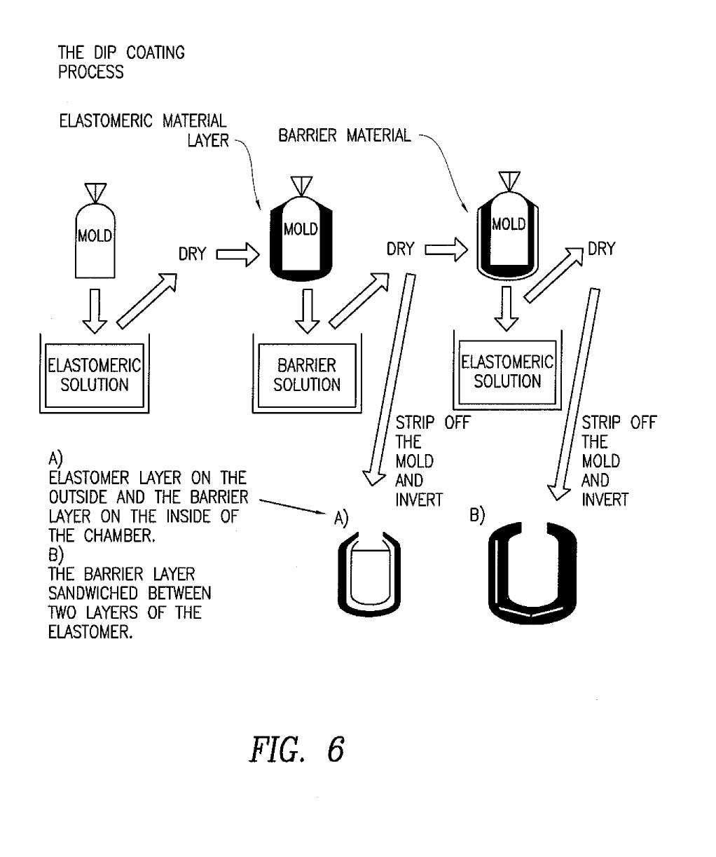

Depicted in FIG. 6 is another preferred process for manufacturing the flexible barrier membrane of the invention (10) employs a first stretchable film layer or substrate (12) of a natural rubber, synthetic rubber or other elastomeric or any plasticized plastic material such as PVC(Vinyl) or the like that is formed in a dipping process by dipping a mold of the shape of the elastomeric chamber to be manufactured into dipping tank containing an elastomeric latex or similar polymer solution. Depending on the solution's viscosity and solids content, different thicknesses of the elastomeric substrate material are deposited onto the mold. The deposited material is heated and dried. This dried casting of the substrate (12) is then dipped into a solution of the barrier material (14) of this invention to form a thin layer of barrier material (14) over the elastomeric substrate (12). The barrier solution is formulated to contain between 8 and 50% solids and to have a viscosity of between 200 and 120,000 centipoise depending on the thickness of barrier coating (14) that is required for the final performance of the component being manufactured. The mold carrying the elastomeric substrate (12) and wet barrier coating (14) is then dried at temperatures between 40 & 200 deg C. in a convection oven until partially dry. The barrier material (14) while in a state of being partially dry and having a moisture content of between 1 and 20% is then stripped off the mold so that it is now inside-out with the barrier material (14) forming the inside wall of an elastomeric chamber (like a balloon) and the elastomeric material (12) now forms the outside wall of the manufactured component. The barrier membrane (10) components so formed are sealed by insertion and curing or laminating a valve or other type of sealing device into the open end of the cast chamber. The barrier layer (14) is now sealed inside the elastomeric chamber and the coating adheres strongly to the inside of the elastomeric chamber's walls, contains preferably between 2 and 14% residual water content and remains elastic and flexible. An alternative to this method would be to dip another elastomeric coating on top of the barrier coating (14) to create a sandwich membrane comprising a barrier layer (14) between two elastomeric layers (12) and (16). To enhance quality multiple dipping of each coating can be employed.

In an alternative application of this method, a fully formed component of an inflatable product, in any shape (e.g. a ball bladder that is spherical), is covered with strips of barrier film (14) that are applied with polymer cement to the substrate (12). The strips are placed north to south pole on the sphere and are overlapped and cemented at the edges as they are located onto the spherical elastomeric substrate. Eventually, it is preferred that they cover the full surface of the component like petals of a flower cover a bud. This configuration consisting of the rubber substrate (12) and overlaid barrier films (14) is then covered by a second rubber film (16) that is laid onto the barrier film (14) in the same way that the barrier film (14) was laid onto the initial elastomeric substrate (12). An adhering formulation may be used at this point to adhere the second elastomeric film (16) on to the barrier film (14). Alternatively a malleable and curable elastomeric formulation can be used as in the case of natural or synthetic rubber. The whole elastomeric sphere component consisting of an elastomeric inner sphere (12), an elastic barrier layer (14) and an outer elastomeric sphere (16) is then cured or laminated in a mold at temperatures between 120° and 200° C. while applying air pressure between 1 kg/cm2 and 14 kg/cm2 to the internal surface of the inner elastomeric sphere. The shape of the membrane can be flat, or any shape or cut length. This example uses a sphere to demonstrate the art as applied to ball manufacture.

### EXAMPLES

### Example 1

In particular 9.7 mm thick soft PVC sheet covered with a 1.5 mil barrier coating of this invention and tested on an air seepage tester that measures the volumetric air diffusion rate through a fixed area of film. The results are in cc/hr/m2. See chart 1. The barrier coating reduced air seepage through the PVC film by approximately 30 fold. An standard consumer PVC air mattress using this same barrier membrane configuration would stay inflated for more than a year.

### Example 2

The 9.7 mm thick soft K80 PVC sheet used in example 1 was cut into 3 parts. One was covered with a 1.5 mil barrier coating of this invention using a fully hydrolyzed PVOH, another with a partially hydrolysed film and the third was used as a control. The membranes were each tested for the air diffusion tester. The results showed that the fully hydrolyzed membrane was 30 times better than the control and almost 3 times better than the partially hydrolyzed PVOH formulation. See chart 2.

### Example 3

To maintain the barrier membranes flexibility it is important to provide a formulation of barrier material that can retain its moisture content between 2 and 14% by weight after going through a curing process. Sugar alcohols, Dextrose monohydrate and cloisite clay are advantageous in this respect. Barrier membranes comprising 80% Elvanol 70-31(fully hydrolyzed) and 20% dextrose or sorbitol and up to 5% weight nano-clay(Cloisite-Na+) were compared to a partially hydrolyzed PVOH and a commercially available fully hydrolyzed PVOH, by Kuraray Inc.

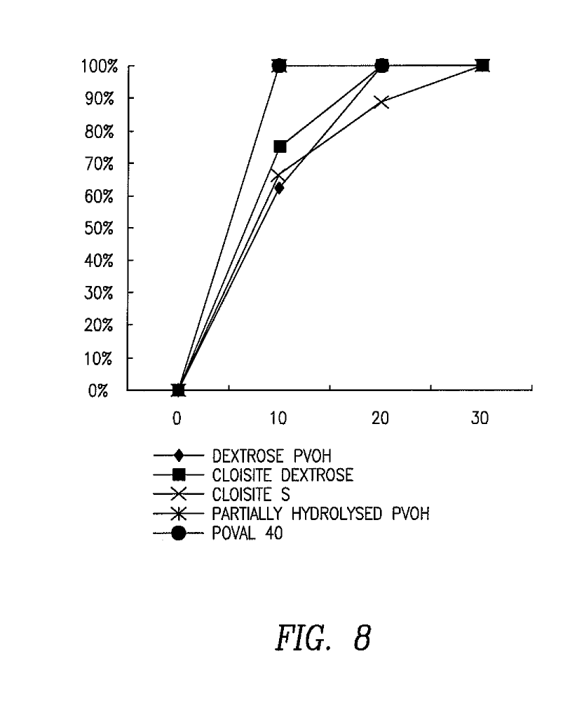

The test measured the percent of initial moisture content remaining in the membrane per minute at 150 deg C.—a typical curing temperature employed by rubber manufacturers. The results showed that the sugar alcohol or saccharide plasticized PVOH retained more than 40% of their original moisture for up to 20 minutes while the other gave up 100% of their water in less than 10 minutes. In a typical curing process lasting up to 12 minutes the barrier membranes of this invention retain moisture, remain stretchable and maintain their gas impermeability. The other films become brittle and crack while under many cycle of flexing. (See FIG. 8)

### Example 4

A film comprising 80% filly hydrolysed PVOH, 20% glycerol plasticizer was incorporated into a ball and cured at 150° C. for 10 min. No sugar alcohol or saccharide plasticizer of this invention was included. The bass was put through a standard ball manufacturers 12,000 cycle durability test and inspected.

### Example 5

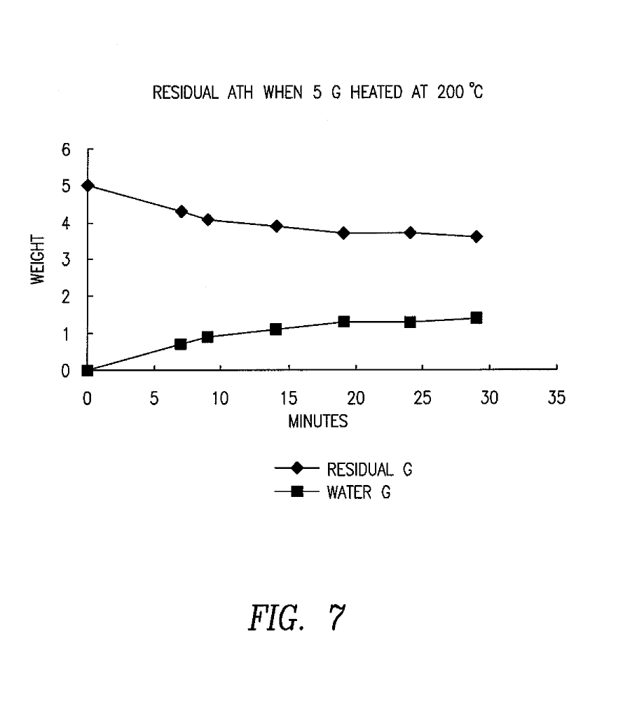

This test checked the rate of water generation in a 5 g sample of aluminum trihydrate. The analysis shows that A12(OH)3(ATH) can be used to generate water in films to keep them plasticized and flexible so that they do not crack when stretched. In this test moisture was given off for up to 30 minutes at 200° C. A typical processing cure cycle only lasts 10 minutes at such temperatures. For very high temperature processes addition of a hydrating agent like ATH is a good method for maintaining film moisture. ATH provides up to 34% by gross weight as water of hydration (See FIG. 7).

### Example 6

Comparison of the rate as a percentage total moisture loss through various membrane barrier films. The samples were subjected to 150° C. for up to 30 minutes at atmospheric pressure. The sugar alcohol formulations comprising 20% by weight Dextrose Monohydrate and those comprising 20% Sorbitol and 5% weight Cloisite (montmorillinate clay) performed the best with slowest rate of moisture loss. At the end of a 10 minute cure cycle the membranes still contained close to 40% of their initial moisture content and remained subtle and flexible. These samples comprised 80% weight Elvanol 7130. Partially hydrolyzed PVOH film and POVAL 1.5 mil thick film lost 100% of their initial water content after being heated to 150° C. for extended period of time as would be experienced in an elastomer curing cycle. The films became embrittled and were easily damaged and cracked. See FIG. 7 for a test showing this film in a ball after curing (See FIG. 8).

### Example 7

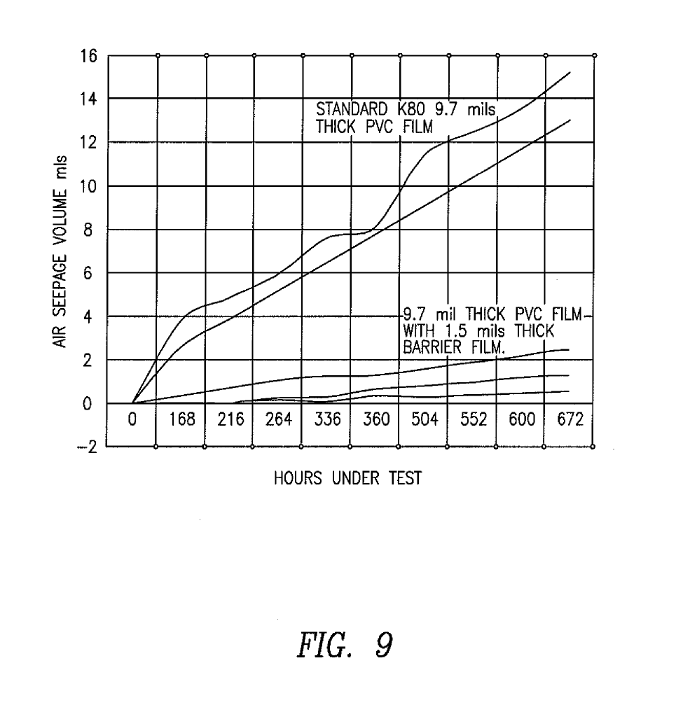

Comparison of membrane seepage performance between a PVC sheet used in air mattresses and PVC sheets treated with different formulations of the barrier films of this invention. 80% PVOH, 20% Sugar alcohols barrier films. (See FIG. 9).

### Example 8

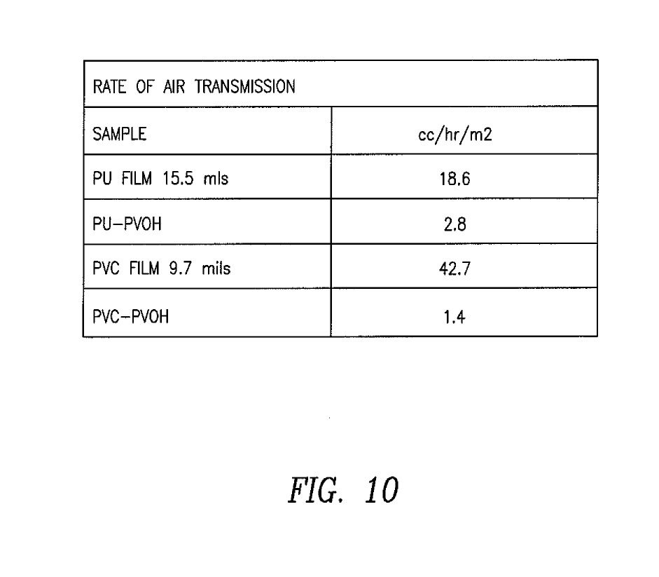

Comparison of the rate of air diffusion through various membrane materials treated and not treated with the barrier material of this invention. For a Polyurethane thermoplastic (TPU) cut from a 15.5 mils thick film that was coated with a 1.5 mil film of this invention the improvement in air retention was 7 fold. For a PVC sheet cut from a 9.7 mils thick film that was coated with a 1.5 mil barrier film of this invention the improvement in air retention was 30 fold. (See FIG. 10).

### Example 9

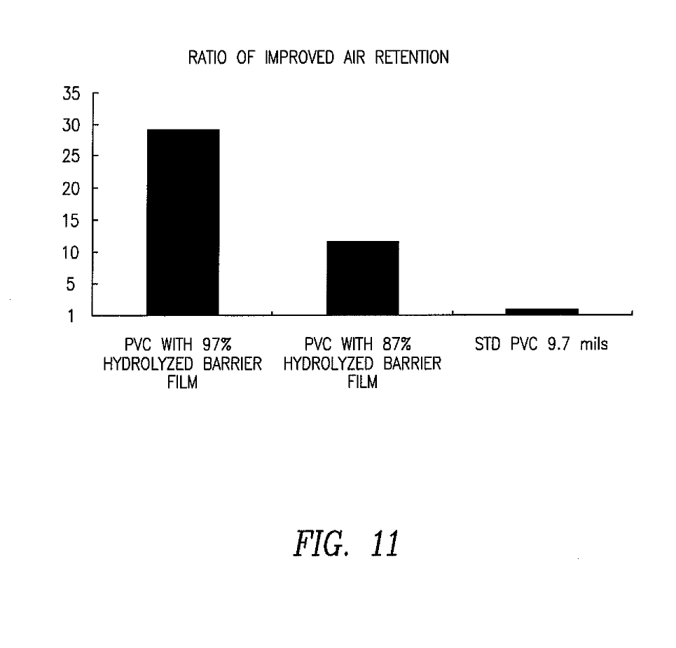

Comparison of air retention performance of inflatable articles made from PVC, PVC treated with a highly hydrolyzed PVOH and a partially hydrolyzed PVOH barrier material of this invention. 80% PVOH, 20% glycerol plasticizer barrier films. (See FIG. 11)

### Example 10

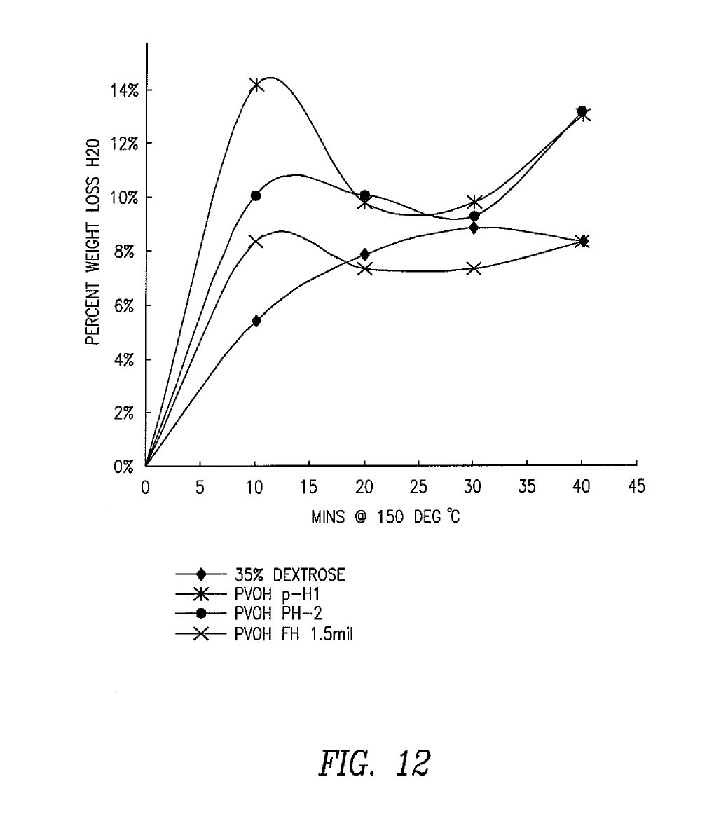

Comparison of the rate of barrier film moisture loss for various PVOH films of this invention. PVOH p-H1 and PH-2 are partially hydrolyzed films, PVOH FH is a fully hydrolyzed film. All the films were subjected to a simulated curing operation at 150° C. for up to 40 minutes. Without the sugar alcohols/saccharide plasticizers of this invention the barrier membranes were 100% dry within 10 minutes. They became brittle, easily cracked and loss their air barrier properties. (See FIG. 12)

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A barrier membrane for flexible articles comprising:
a) a first stretchable film layer, wherein said first stretchable film layer is substantially water impervious;
b) a barrier film layer, wherein said barrier film layer is substantially gas impermeable; and
c) a second stretchable film layer, wherein said second stretchable film layer is substantially water impervious;
wherein said barrier film layer comprises a residual moisture level of between 1% and 20% by weight.

2. The barrier membrane of claim 1 wherein said barrier film layer comprises a polymer selected from the group consisting of PVOH, EVOH and PVDC.

3. The barrier membrane of claim 1 wherein said wherein said barrier film layer comprises a plasticizer.

4. The barrier membrane of claim 3 wherein said plasticizer comprises 5% to 50% of said barrier film layer.

5. The barrier membrane of claim 3 wherein said plasticizer is selected from the group consisting of sugar alcohols, saccharides and glycerols.

6. The barrier membrane of claim 1 wherein said barrier film layer comprises additional ingredients selected from the group consisting of water-shedding compounds, silica gel, aluminum trihydrate, magnesium hydroxide, activated carbon, highly hydrated organic and inorganic compounds, antioxidants, biocide, anti-mold materials, sodium diacetate, calcium proprionate, potassium sorbate, coloring fillers, viscosity thickeners, non-ionic surfactants, Triton-x® surfactants, viscosity stabilizers, thiocyanate, phenol, butyl alcohol, isopropyl alcohol, starch, methyl cellulose, polyacryl amide, alginic acid soda, clays, calcium carbonate, dextrin, casein, nano-clays, polyurethane, and elastomers.

7. The barrier membrane of claim 1 wherein said first and second stretchable film layers comprise an elastomeric composition selected from the group consisting of natural rubber, synthetic rubber, plastic material and PVC.

8. A barrier membrane for flexible articles comprising a stretchable film layer, wherein said stretchable film layer is substantially water impervious, and a barrier film layer, wherein said barrier film layer is substantially gas impermeable, and wherein said barrier film layer is encapsulated by said stretchable film layer in the configuration of a closed, gas-filled chamber.

9. The barrier membrane of claim 8 wherein said barrier film layer comprises a residual moisture level of between 1% and 20% by weight.

10. The barrier membrane of claim 8 wherein said barrier film layer comprises a polymer selected from the group consisting of PVOH, EVOH and PVDC

11. The barrier membrane of claim 8 wherein said wherein said barrier film layer comprises a plasticizer.

12. The barrier membrane of claim 11 wherein said plasticizer comprises 5% to 50% of said barrier film layer.

13. The barrier membrane of claim 11 wherein said plasticizer is selected from the group consisting of sugar alcohols, saccharides and glycerols.

14. The barrier membrane of claim 8 wherein said barrier film layer comprises additional ingredients selected from the group consisting of water-shedding compounds, silica gel, aluminum trihydrate, magnesium hydroxide, activated carbon, highly hydrated organic and inorganic compounds, antioxidants, biocide, anti-mold materials, sodium diacetate, calcium proprionate, potassium sorbate, coloring fillers, viscosity thickeners, non-ionic surfactants, Triton-x® surfactants, viscosity stabilizers, thiocyanate, phenol, butyl alcohol, isopropyl alcohol, starch, methyl cellulose, polyacryl amide, alginic acid soda, clays, calcium carbonate, dextrin, casein, nano-clays, polyurethane, and elastomers.

15. The barrier membrane of claim 8 wherein said first and second stretchable film layers comprises an elastomeric composition selected from the group consisting of natural rubber, synthetic rubber, plastic material and PVC.

16. A process for preparing a barrier membrane for flexible articles comprising the steps of:
a) providing a first, water impervious stretchable film layer;
b) applying a gas impermeable barrier film layer onto said first stretchable film layer;
c) applying a second, water impervious stretchable film layer onto said barrier film layer; and
(d) adhering the layers together using high pressure and high temperature, whereby said barrier film layer comprises a residual moisture of 1% to 20% by weight.

17. The process of claim 16 wherein said barrier film layer comprises a polymer selected from the group consisting of PVOH, EVOH and PVDC.

18. The process of claim 16 wherein said wherein said barrier film layer comprises a plasticizer.

19. The process of claim 18 wherein said plasticizer comprises 5% to 50% of said barrier film layer.

20. The barrier membrane of claim 18 wherein said plasticizer is selected from the group consisting of sugar alcohols, saccharides and glycerols.
